(19) United States
(12) Patent Application Publication
(10) Pub. No.: US 2022/0394059 A1
(43) Pub. Date: Dec. 8, 2022

(54) LIGHTWEIGHT TUNED DDOS PROTECTION

(71) Applicant: Level 3 Communications, LLC, Broomfield, CO (US)

(72) Inventors: Michael FELDPUSCH, Murrells Inlet, SC (US); Peter BRECL, Highlands Ranch, CO (US); Dan LUTHER, Claremore, OK (US)

(21) Appl. No.: 17/805,929

(22) Filed: Jun. 8, 2022

Related U.S. Application Data
(60) Provisional application No. 63/208,269, filed on Jun. 8, 2021.

(51) Int. Cl. H04L 9/40

(52) U.S. Cl. CPC H04L 63/1458

(57) ABSTRACT

Systems and methods for improved DDoS mitigation by utilizing lightweight and tuned mitigation techniques are provided. A lightweight, tuned DDoS system provides protection from DDoS attacks by hosting a container hypervisor on a server that is isolated from other server processes. The container hypervisor may include protection containers and forensic containers. Traffic received at the server is directed through the protection containers to filter out malicious traffic prior to valid traffic being sent to other system processes. The protection containers may be specifically tuned to the service provided by the server. Additionally, malicious traffic may be directed from the protection containers to the forensics containers for extraction of forensic information to be directed to external threat intelligence systems for analysis. As threats change, the threat intelligence system may periodically send modification information to the server to modify the protection schemes of the protection containers in the container hypervisor.

### CROSS-REFERENCE TO RELATED APPLICATIONS

This application claims the benefit of U.S. Provisional Application No. 63/208,269 filed Jun. 8, 2021, entitled “Lightweight tuned DDOS protection,” which is incorporated herein by reference in its entirety.

### BACKGROUND

A distributed-denial-of-service (DDoS) attack is an act of using a network or computationally intense query to take down or disrupt a system or client device connection. DDoS attacks may be volumetric attacks or non-volumetric attacks. A flood or volumetric DDoS attack generally utilizes multiple computing systems as sources of traffic to overwhelm the bandwidth of a particular target or targets. Non-flood or non-volumetric DDoS attacks include queries focused on overburdening or exhausting specific resources of a system. Carrying out a DDoS attack may also include taking control of multiple computing machines, potentially including internet-of-things (IoT) devices, to operate as bots in a botnet that launches the attack.

It is with respect to these and other general considerations that the aspects disclosed herein have been made. Also, although relatively specific problems may be discussed herein, it should be understood that the examples should not be limited to solving the specific problems identified in the background or elsewhere in this disclosure.

### SUMMARY

Examples of the present disclosure describe systems and methods for lightweight, tuned DDoS system protection. In an aspect, a computer-implemented method for hosting a container hypervisor for mitigating a distributed-denial-of-service (DDoS) attack is disclosed. The computer-implemented method includes hosting the container hypervisor on a server, the container hypervisor comprising a set of protection containers. The method further includes receiving a query from a client device over a network and directing the query to a protection container of the set of protection containers, the protection container associated with a protection scheme based on at least one query characteristic. Additionally, the method includes determining that the query is valid, based on the protection scheme. Based on determining that the query is valid, the method includes directing the query to a processor of the server for processing.

In an example, the method further includes: processing the query to generate a response; and sending the response to the client device over the network. In another example, the container hypervisor requests, manages, and allocates computing resources of the server based on one of: the query and the set of protection containers. In a further example, the protection container is a first protection container, the protection scheme is a first protection scheme, and wherein the set of protection containers includes a second protection container associated with a second protection scheme. In yet another example, the method further includes: based on determining that the query is valid based on the first protection scheme, directing the query to the second protection container; and determining that the query is valid based on the second protection scheme, wherein directing the query to the processor is based on determining that the query is valid based on the first protection scheme and the second protection scheme. In still a further example, the server is a first server, and the method further includes: querying a second server, by the processor of the first server, to generate a response to the query.

In another example, the first server is a public server and the second server is a private server. In a further example, the container hypervisor is a first container hypervisor with a first set of protection containers hosted on the first server and wherein the second server is hosting a second container hypervisor with a second set of protection containers. In yet another example, the first set of protection containers differs from the second set of protection containers based on one of: including different protection containers and arrangement of containers. In still a further example, the method further includes: directing the query through the second set of protection containers; determining that the query is valid, based on the second set of protection containers; based on determining that the query is valid based on the second set of protection containers, directing the query to a second processor of the second server for processing; processing the query at the second processor to generate the response; and sending the response to the first server. In another example, determining that the query is valid is based on a query characteristic, wherein the query characteristic is one of: a location of the client device; a location of the server; an IP address of the client device; a packet size; a packet bandwidth; and a computing resource associated with generating a response to the query.

In another example, the container hypervisor is a first container hypervisor with a first set of protection containers hosted on the first server and wherein the second server is hosting a second container hypervisor including a second set of protection containers and a set of forensics containers, the method further including: directing the query through the second set of protection containers; determining that the query is invalid, based on the second set of protection containers and the query characteristic; based on determining that the query is invalid, directing the query to the set of forensics containers; identifying forensic information based at least in part on the query characteristic; and sending the forensic information to an external system. In yet another example, the container the forensic information is an aggregation of query characteristics including the query characteristic associated with the invalid query. In still a further example, the query is a first query, the client device is a first client device, and the hypervisor container further includes a set of forensics containers, the method further including: receiving a second query from a second client device over the network; directing the second query to the protection container of the set of protection containers; determining that the second query is invalid, based on the protection container and a query characteristic; based on determining that the second query is invalid, directing the second query to the set of forensics containers; identifying forensic information based at least in part on the query characteristic; and sending the forensic information to an external system. In another example, the second query is not received by the processor of the server. In a further example, the method further includes: receiving container modification information from the external system, the container modification information based at least in part on the forensic information; and updating the set of protection containers based on the container modification information.

In another aspect, a computer-implemented method for hosting a container hypervisor for mitigating a distributed-denial-of-service (DDoS) is provided. The computer-implemented method includes: hosting the container hypervisor on a server, the container hypervisor comprising a set of protection containers and a set of forensics containers. The method further includes receiving a query from a client device over a network and directing the query through the set of protection containers. Additionally, the method includes determining that the query is malicious, based on at least one protection container of the set of protection containers and a query characteristic. Based on determining that the query is malicious, the method includes directing the malicious query through the set of forensics containers. The method also includes identifying forensic information based at least in part on the query characteristic and sending the forensic information to a threat intelligence system external to the server.

In an example, the query characteristic is one of: a location of the client device; a location of the server; an IP address of the client device; a packet size; a packet bandwidth; and a computing resource associated with generating a response to the query. In another example, the method further includes: receiving container modification information from the threat intelligence system, the container modification information based at least in part on the forensic information; and updating the set of protection containers based on the container modification information.

In further aspect, a system for hosting a container hypervisor for mitigating a distributed-denial-of-service (DDoS) is disclosed. The system includes a processor and memory storing instructions that when executed by the at least one processor cause the system to perform a set of operations. The set of operations includes hosting the container hypervisor on the system, the container hypervisor isolated from the processor and comprising a set of protection containers and a set of forensics containers. The set of operations further includes receiving a query from a client device and directing the query to the container hypervisor through the set of protection containers. Additionally, the set of operations includes determining that the query is invalid, based on at least one protection container of the protection containers and a query characteristic associated with the query. Based on determining that the query is invalid, the set of operations includes directing the query through the set of forensics containers and identifying forensic information based at least in part on the query characteristic. The set of operations also includes sending the forensic information form the container hypervisor to a threat intelligence system external to the server.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1A depicts an example system for mitigating a DDoS attack.

FIG. 1B depicts an example configuration of the server in FIG. 1A.

FIG. 1C depicts a schematic of an example flow path for a valid query of the server of FIG. 1B by a client device.

FIG. 1D depicts a schematic of an example flow path for an invalid query of the server of FIG. 1B by a client device.

FIG. 2A depicts a schematic of an example flow path for a valid query in a multiple-server system for mitigating DDoS attacks.

FIG. 2B depicts a schematic of an example flow path for an invalid query in a multiple-server system for mitigating DDoS attacks.

FIG. 3A depicts another example system for mitigating DDoS attacks across a network.

FIG. 3B depicts another example system for mitigating DDoS attacks across multiple networks.

FIG. 4 depicts an example operating environment.

FIG. 5 depicts an example method for a lightweight, tuned DDoS system.

FIG. 6 depicts another example method for a lightweight, tuned DDoS system.

### DETAILED DESCRIPTION

A DDoS attack overwhelms or overburdens a target system and is thus undesirable. Mitigation of DDoS attacks prior to overwhelming or overburdening the system allows system performance to be uninterrupted by a malicious query. Mitigation of a DDoS attack generally includes filtering traffic directed to the target that is malicious (e.g., part of a DDoS attack). After the malicious traffic is filtered, the valid, non-malicious traffic is sent to the target system for processing.

Solutions to DDoS attacks may include a physical box or virtualization for receiving network traffic in front of the server. The use of a physical box, however, presents a point of failure. If the physical box were to fail, then the system, which is still running, is subject to attack. Further, if a physical box is protecting multiple systems, then the multiple systems would be subject to attack upon failure of a single physical box. Additionally, deploying, replacing, and updating individual physical boxes is expensive, time-consuming, and relatively infrequent as compared to ongoing evolution of attacks (e.g., updating may not timely address changes in attack schemes or techniques). For example, updating a physical box may not occur until after DDoS attacks have transitioned to new methods.

As another alternative, a virtual machine may be used to protect against DDoS attacks. Virtual machines, however, may require substantial overhead for the hosting device. When using a virtual machine as a firewall, the hosting device relinquishes an amount of processing power, memory, and/or disk space, regardless of how much of a dedicated resource is actually required at any given time. Thus, utilizing a virtual machine for protection against DDoS attacks may over-allocate or under-allocate resources, resulting in an inefficient use of computing resources.

The present technology provides systems and methods for improved DDoS mitigation by utilizing lightweight and tuned mitigation techniques. A lightweight, tuned DDoS system provides protection from DDoS attacks by hosting a container hypervisor on a server that is isolated from other server processes. The container hypervisor may include protection containers and forensic containers. Traffic received at the server is directed through the protection containers to filter out malicious traffic prior to valid traffic being sent to other system processes. The protection containers may be specifically tuned to the service provided by the server. Additionally, malicious traffic may be directed from the protection containers to the forensics containers for extraction of forensic information to be directed to external threat intelligence systems for analysis. As threats change, the threat intelligence system may periodically send modification information to the server to modify the protection schemes of the protection containers in the container hypervisor. Thus, the present technology provides for chaining services within a target system prior to traffic reaching system processes such that the target system is protected internally, while directing attack forensic information to threat intelligence systems for updating of protection containers.

By hosting a container hypervisor, a target system (or server or device) may efficiently use and allocate computing resources based on how much of a resource the containers in the container hypervisor need to function at a given time. The container hypervisor then manages allocation of the resources. Additionally, a container hypervisor may be flexible or adaptable for a variety of systems. For example, a container hypervisor may have a standardized environment. Additionally, the container hypervisor may not have dependency on versioning. Unlike an application running on a system, the container hypervisor is isolated from all other system processes. In examples, the container hypervisor is located on the system so as to be the first part of the system to receive packet traffic, prior to the packet affecting other system processes (e.g., after a packet exits the container hypervisor and is determined to be valid, the packet may be directed to other system processes).

A container hypervisor is lightweight by having a reduced amount of system resources consumed. Additionally, a container hypervisor is flexible and portable, allowing containers to be easily updated, moved, added, removed, or adjusted based on function, operation, location, etc. Thus, a container hypervisor may be tuned to a specific system by adjusting container functions or operations, changing container locations, or adding or removing containers. A container hypervisor may therefore be adjusted to detect and mitigate all types of DDoS attacks, including flood/volumetric, non-flood/non-volumetric attacks, and application layer attacks. In examples, non-volumetric attacks may include application layer attacks. The container hypervisor may exist anywhere on a target system prior to the system processor. For example, a container hypervisor may be self-contained in a system after a network interface card (NIC) or integrated into a NIC of the target system.

A container hypervisor also presents solutions to various problems presented with other systems, above. Because the container hypervisor is integrated into the target system, there is no point of failure. For example, the container hypervisor may only fail when the system goes down, and if the system goes down then malicious traffic will not reach the system processes. Additionally, protection schemes of the containers in the container hypervisor may be updated or replaced quickly and timely with protection against a variety of DDoS attacks as they evolve. For example, protection schemes of the containers may be developed in-house or purchased from a vendor for a specific technology area, such as cyber-security, and may be quickly implemented as containers using the systems and methods set forth herein. Moreover, system resources are allocated on an as-needed basis to the container hypervisor without over-allocation or under-allocation. Additional features of the present technology are further described below.

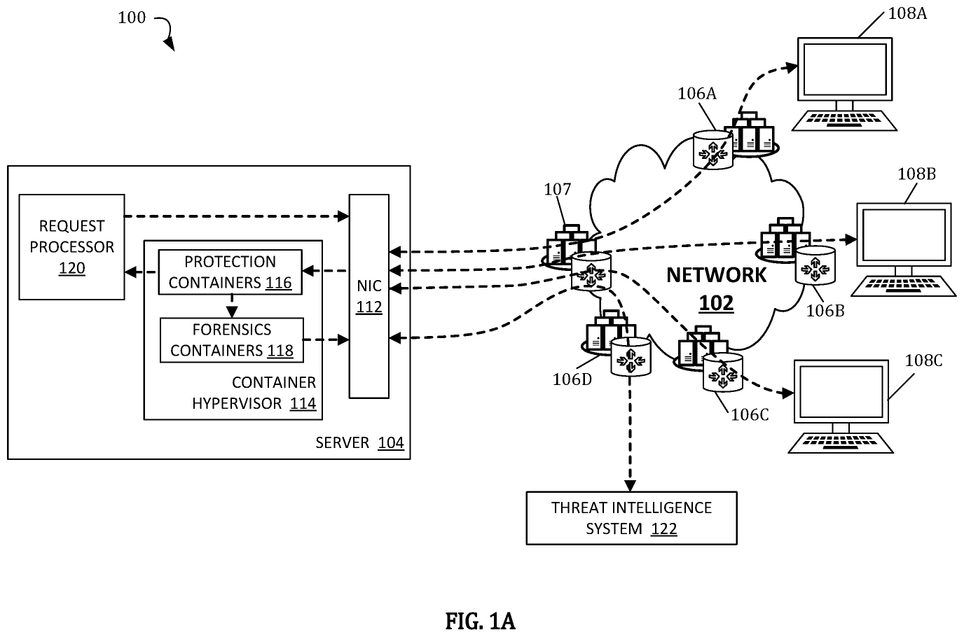

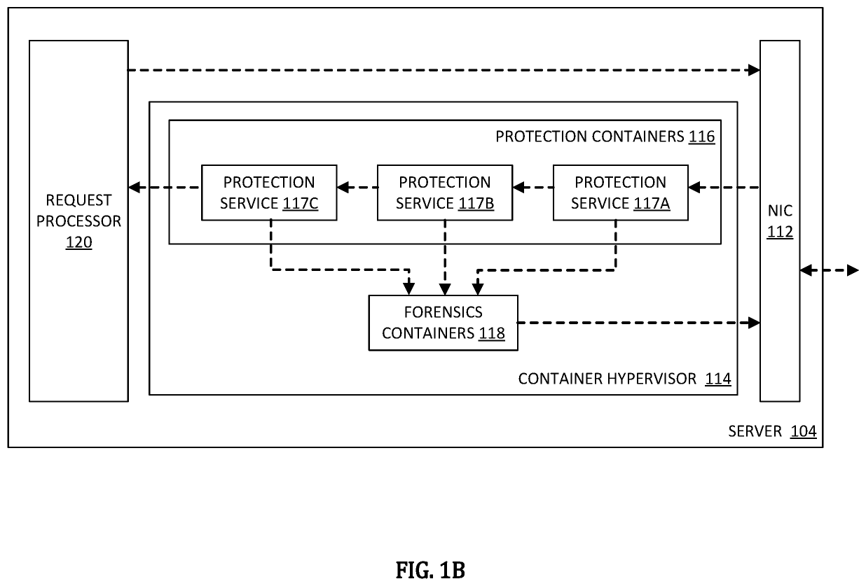

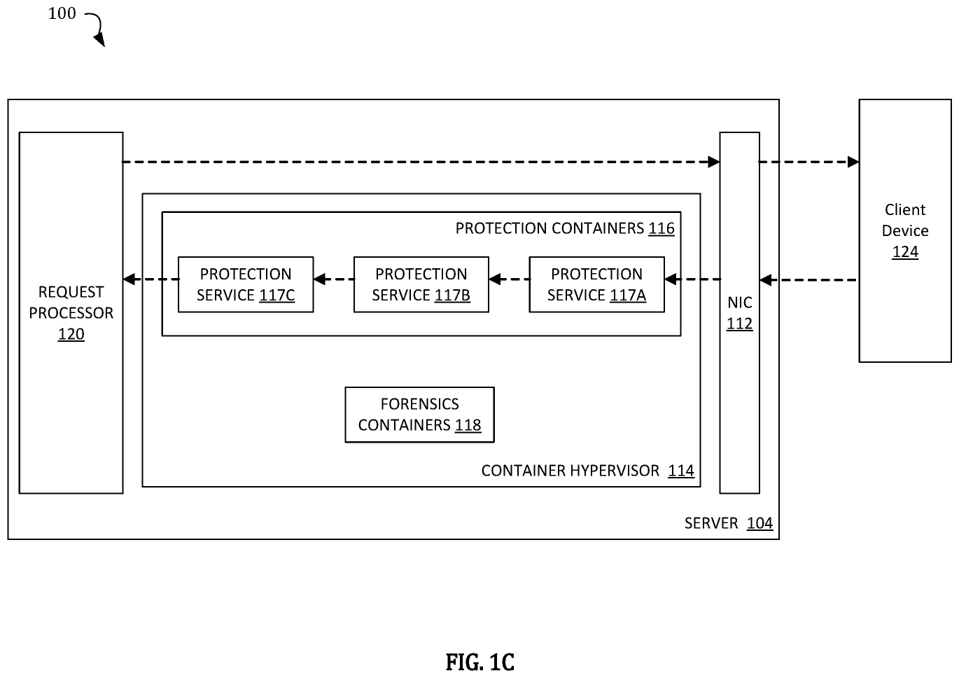

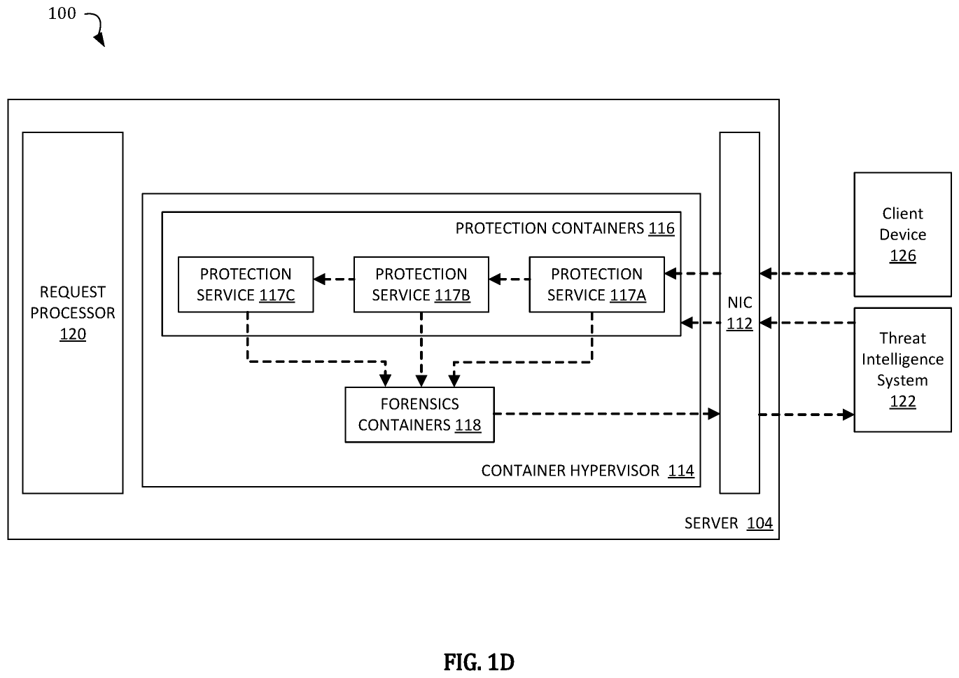

FIG. 1 depicts a system 100 for mitigating a DDoS attack. As shown, the system 100 includes a network 102 connected to a target server 104, client devices 108A-C, and a threat intelligence system 122.

Client devices 108A-C and the threat intelligence system 122 may connect to the network 102 via access points 106A-D, respectively, such as at one or more gateways. The client devices 108A-C may be associated with residential customers or larger scale customers, such as organizations. Client devices 108A-C, as used herein, may refer to the machine or group of machines for a particular customer account to which the network 102 provides service. While each of client devices 108A-C and the threat intelligence system 122 are depicted as a single device, the client devices 108A-C and threat intelligence system 122 may include a plurality of devices, such as a plurality of devices associated with a block of IP addresses.

Each of the access points 106A-D may include routing technology and additional computing hardware and software to process requests and perform services requested by the client devices 108A-C. The access points 106A-D may be network gateways and/or located at central offices (COs). Routing technology may handle initial routing of traffic into the network 102. The routing technology may be virtualized and part of virtual network orchestration scheme. The computing hardware located at the access points 106A-D may also include software, such as a hypervisor, that supports the hosting of virtual machines. The virtual machines are emulations of physical computer systems and can execute virtual network functions (VNFs). VNFs are processes that handle specific network functions, such as scrubbing of traffic, firewalls, and load balancing. Multiple virtual machines and VNFs can be executed on the hardware located at the access points 106A-D. Although FIG. 1A shows one example of an architecture for network 102, any network architecture should be appreciated, which may vary from provider-to-provider or business-to-business.

The target server 104 may connect to network 102 via a target access point 107. Target access point 107 may include one or more of the features of access points 106A-D. Alternatively, target access point 107 may not include attack-protection technologies, such as virtualized routing technology, a VNF, etc. Packet traffic from one or more client devices 108A-C or threat intelligence system 122 may be sent to the target server 104 via network 102 and received at a network interface of the system via target access point 107.

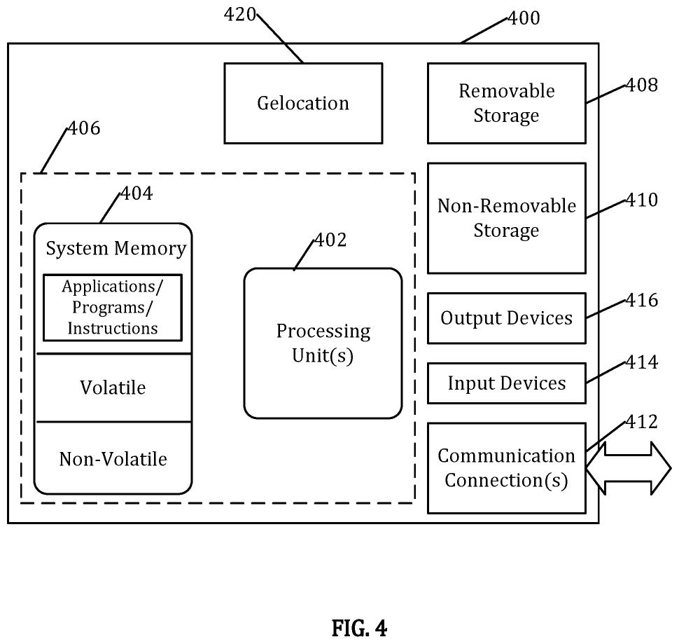

The target server 104, as shown, includes a network interface card 112 (NIC 112), a container hypervisor 114, and a request processor 120. Other components should be appreciated, such as the components described below with respect to FIG. 4. The target server 104 may provide a variety of services, such as servicing a website, servicing an application, a domain name system (DNS), or any external-facing system that may be a subject of a DDoS attack.

The NIC 112 be a port that communicatively couples the target server 104 to the network 102 and other devices (e.g., client devices 108A-C or threat intelligence system 122) connected to the network 102. For example, traffic entering the server 104 from the network 102 or exiting the server 104 into the network 102 may pass through the NIC 112. The NIC 112 may be internal to the server 104, such as on one or more chip(s) of the motherboard. Alternatively, the NIC 112 may be an add-on to the server 104, such as a NIC card added via a peripheral component interconnect (PCI) slot. Additionally, the NIC 112 may be connected to the network via a wired or wireless connection. The NIC 112 may include hardware to allow the NIC 112 to perform physical layer processes and data link layer processes.

The container hypervisor 114 is software running on the server 104 to deliver, run, orchestrate, and manage containers on the server 104, such as Docker, Kata, Kubernetes, CoreOS Rkt, Mesos Containerizer, etc. The container hypervisor 114 may include one or more protection containers 116 (e.g., a set of protection containers) and at least one forensics container 118 (e.g., a set of forensics containers). The protection containers 116 determine if packets are malicious. The forensics containers 118 analyze traffic determined to be malicious or invalid (e.g., as determined by the protection containers 116) and extract forensic information. The protection containers 116 may be formatted in a one-to-many environment, such that multiple protection containers may be implemented to scrub traffic of malicious packets, which is further described below. The protection containers 116 may be one or more sets of protection containers. The container hypervisor may direct flow of traffic through the protection containers 116 in series, in parallel, or a combination of both. The protection containers 116 may allow for service chaining, which is the act of chaining one or more services (in this case, protection containers 116) in a chain such that a packet flows from one service to another. Components and functions of the container hypervisor 114, including the protection containers 116 and forensics containers 118, are further described below.

The request processor 120 performs various system processes, which may be associated with processing a request received from a client device, e.g., client devices 108A-C, or the threat intelligence system 122. For example, the request processor 120 may include workloads, applications, kernels, other operating system components, or other system processes or components that may be subject(s) of a non-flood or non-volumetric DDoS attack.

The threat intelligence system 122 may be external to the server 104 (e.g., as connected over network 102). The threat intelligence system 122 may perform threat intelligence analysis for server 104, among other servers, based on information sent to the threat intelligence system 122 (e.g., from server 104 or another server not shown). The threat intelligence system 122 may be under the same or different ownership or control as that of server 104. Other aspects of the threat intelligence system 122 are described below.

In the example depicted in FIG. 1A, packet traffic, otherwise referred to herein as requests or queries, may be sent by client devices 108A-C over the network 102 and received by the server 104 at the NIC 112. The server 104 directs the received traffic into the container hypervisor 114. The container hypervisor 114 requests and allocates computing resources and directs the traffic through containers to identify and scrub malicious traffic. Malicious traffic, such as traffic associated with a DDoS attack, may originate from one or more of the client devices 108A-C. For instance, a client device 108A may be infected with a virus or malware that causes the client device 108A to act as bot in botnet-based attack.

To determine if traffic is malicious, the container hypervisor 114 directs the traffic through protection containers 116 for evaluation of malicious activity. If the protection containers 116 determine that traffic is malicious or invalid, traffic is directed into forensics containers 118 for analysis and extraction of forensic information. The forensic information extracted from the malicious or invalid traffic by the forensics containers 118 is then sent out of the server 104 (e.g., through the NIC 112) to a threat intelligence system 122 (e.g., over network 102). Thus, invalid or malicious traffic does not reach other system processes. Alternatively, if traffic is determined to be valid or clean, the traffic is directed from the protection containers 116 to a request processor 120 of the server 104. The request processor 120 processes the scrubbed, clean traffic and determines a response. The response is then generated and sent (e.g., through the NIC 112) to a client device from which the traffic or query originated (e.g., over network 102).

FIG. 1B depicts an example configuration of the server in FIG. 1A. In particular, FIG. 1B depicts an example configuration for components of the container hypervisor 114. As shown, protection containers 116 may include a set of protection services 117A-C (otherwise referred to herein as protection schemes, which may be a one-to-one relationship or many-to-one relationship with a protection container) in one or more of the protection containers 116. Although the protection services 117A-C are shown in series in FIG. 1B, it should be appreciated that protection services 117A-C may allow the flow of traffic in parallel, in a combination of series or parallel, in loops, or any other flow path. A single protection container may include one or more protection services (e.g., a set of protection services). For example, one protection container may include one protection service or one protection container may include more than one protection services (e.g., two, three, four, etc.). A set of protection services included in a single protection container may be related in function or otherwise associated with each other for determining malicious traffic. Protection services 117A-C may include assessment of query characteristics, such as internet protocol (IP) addresses of the originating client device, usernames, passwords, URLs, domain names, file hashes, origination location (e.g., city or country), query information, device behavior, device physical characteristics (e.g., screen resolution), user interactions at the querying device (e.g., how clicks or selections are performed, how a mouse is moved, how a screen is touched), etc. Information about the behavior of a querying device or interactions at a querying device may be determined by injecting code into one or more responses from the public DNS server 104, which may evaluate subsequent requests or queries from the client device (e.g., client devices 108A-C). The protection services 117A-C may be implemented using access control mechanisms associated with one or more traffic elements, such as block lists, allow lists, traffic filtering based on known malicious traffic signatures, traffic filtering based on known exploited ports (e.g., layers 4-7) or application-level filtering based on certain types of port level traffic signatures, etc.

The container hypervisor 114 may direct malicious traffic from the protection containers 116 to forensics containers 118. The forensics containers 118 extract or collect information about malicious traffic directed from the protection containers 116. For example, the forensics containers 118 may determine forensic information about malicious traffic such as common characteristics of traffic determined to be malicious, aggregated information about malicious traffic, etc. The container hypervisor 114 may then direct forensic information from the forensics containers 118 outside of the server 104 (e.g., to a threat intelligence system) via the NIC 112. Forensic information may include abnormal traffic patterns, abnormal packet headers, application-specific traffic anomalies, source location(s) of an attack (e.g., a location of a user of a device and/or a location of one or more source machines, such as a city, state, county, region, global positioning coordinates, or other geographic identifier), size of traffic, computing resource type or allocation associated with the traffic, bandwidth consumed by the traffic, or other information associated with any type of DDoS attack that may be server type-specific, business-specific, global, or otherwise.

The techniques described herein for filtering malicious traffic using protection containers 117A-C and/or forensics containers 118 may evaluate maliciousness of a request based solely on the information associated with the request (e.g., independent evaluation of the request) or by actively engaging a client device. For example, a client device making a request may be actively engaged or challenged to evaluate how the device or client device system handles the engagement or challenge in subsequent interactions with the server 104 and/or request processor 120. As otherwise described herein, engaging or challenging the client device may be implemented via code injections in a response to the client device from the server 104. The threat intelligence system 122 may retain information about the reputation of the interrogated client device (an engaged or challenged client device) for faster future decisions regarding requests from that client device, thus reducing the workload on learned requests (e.g., good or bad requests).

FIG. 1C and FIG. 1D show schematics of example flow paths of packet information received at the target server 104. Specifically, FIG. 1C depicts a schematic of an example flow path for a valid query of the server of FIG. 1B by a client device and FIG. 1D depicts a schematic of an example flow path for an invalid query of the server of FIG. 1B by a client device.

In FIG. 1C, a client device 124 sends a valid query to server 104. The valid query is received by the server 104 at the NIC 112. The valid query is then directed from the NIC 112 to a container hypervisor 114. The container hypervisor 114 may be included in the NIC 112 or may exist on the server 104 separate from the NIC 112. The container hypervisor 114 may direct the valid query through one or more protection services 117A-C (or protection containers 117A-C). Because the query is valid, the protection services 117A-C may allow the valid query to pass through the protection containers 116 of the container hypervisor 114. In an example, the valid query may be included in traffic received at the server 104, the traffic that passes through the protection containers 116 of the container hypervisor 114 is cleaned or scrubbed of queries determined to be malicious or invalid by the protection containers. Thus, in this example, a valid query (e.g., the valid query originating from client device 124) may be included in the cleaned or scrubbed traffic that passes through the protection containers 116. The cleaned or scrubbed traffic, including the valid query is then directed to the request processor 120 for processing of the query and generation of a response to the query. A response is then sent from the request processor 120 to the client device 124 via the NIC 112 (e.g., over a network).

As shown in FIG. 1C, multiple protection services 117A-C may be included in the protection containers 116. Each protection service 117A-C may apply filtering of queries using different filtering parameters. A query may be determined to be malicious by any one of the protection services 117A-C. In this example, the query may pass through the first protection service 117A. Because the query is valid, the first protection service 117A may not filter out the query and the query may be passed to the second protection service 117B in the protection containers 116 by the container hypervisor 114. Similarly, the query may then be passed from the second protection container 117B to the third protection container 117C. After passing through the protection services 117A-C of the protection containers 116 (e.g., the query is not filtered by any of the protection services 117A-C as malicious), the valid query may be sent to the request processor 120 for processing. Although FIG. 1C shows three protection services 117A-C with traffic flowing in series, any number of protection services should be appreciated in the protection containers 116 and may allow flow of queries through the protection services 117A-C in any order or in series, parallel, or a combination.

In FIG. 1D, a client device 126 sends a malicious query to server 104. The malicious query is received by the server 104 at the NIC 112, along with other traffic. The traffic, including the malicious query, is then directed from the NIC 112 to the container hypervisor 114. The container hypervisor 114 may direct the malicious query through one or more protection services 117A-C (or protection containers 117A-C). As shown, multiple protection services 117A-C may be included in the protection containers 116. Each protection service 117A-C may apply filtering of queries using different filtering parameters. A query may be determined to be malicious by any one of the protection services 117A-C. For example, the query may pass through the first protection service 117A. If the query is determined to be malicious by the first protection service 117A, then the query may be sent to the forensics containers 118 without reaching any other protection service (e.g., the second protection service 117B or the third protection service 117C). If, alternatively, the first protection service 117A does not filter out the query, the query may be passed to the second protection service 117B in the protection containers 116 by the container hypervisor 114. Because the second protection service 117B may apply different filtering parameters than the first protection service 117A, the query may be sent to the forensics containers 118 by the second protection service 117B. If, alternatively, both the first protection service 117A and the second protection service 117B do not filter the query, the query may be passed to a third protection service 117C. As described above with respect to the second protection service 117B, the third protection service may be based on filtering parameters that are different from the first protection service 117A and the second protection service 117B. Thus, the third protection service 117C may filter different queries than the first protection service 117A or the second protection service 117B. For example, if the query is not filtered by the first protection service 117A or the second protection service 117B and reaches the third protection service 117C for evaluation, then the third protection service 117C may filter the query and send the query to the forensics containers 118. Although FIG. 1D shows three protection services 117A-C with traffic flowing in series, any number of protection services should be appreciated in the protection containers 116 and may allow flow of queries through the protection services 117A-C in any order or in series, parallel, or a combination.

Because the query is malicious, one or more of the protection services 117A-C may divert the malicious query from the protection containers 116 to forensics containers 118 and otherwise prevent the malicious query from reaching the request processor 120 of the server 104. As described herein, the traffic that passes through the protection containers 116 of the container hypervisor 114 is cleaned or scrubbed of queries deemed to be malicious or invalid. Thus, in an example, a malicious query (e.g., the malicious query originating from client device 126) may be filtered or scrubbed from the traffic that passes through the protection containers 116. The invalid or malicious traffic, including the malicious query, is then directed from the protection containers 116 to forensics containers 118 for gathering of forensic information relating to the malicious query and/or other undesirable or harmful traffic. The forensics containers 118 may determine forensics information that may be useful to threat intelligence or malicious traffic detection for the present server 104 (e.g., for future updates to protection services 117A-C or protection containers 116) or other servers. The forensic information is then sent to a threat intelligence system 122 via the NIC 112. The threat intelligence system 122 may analyze the forensic information sent from server 104 and/or other servers and send updates, replacements, or changes to the protection containers 116 to server 104A to improve the protection containers 116.

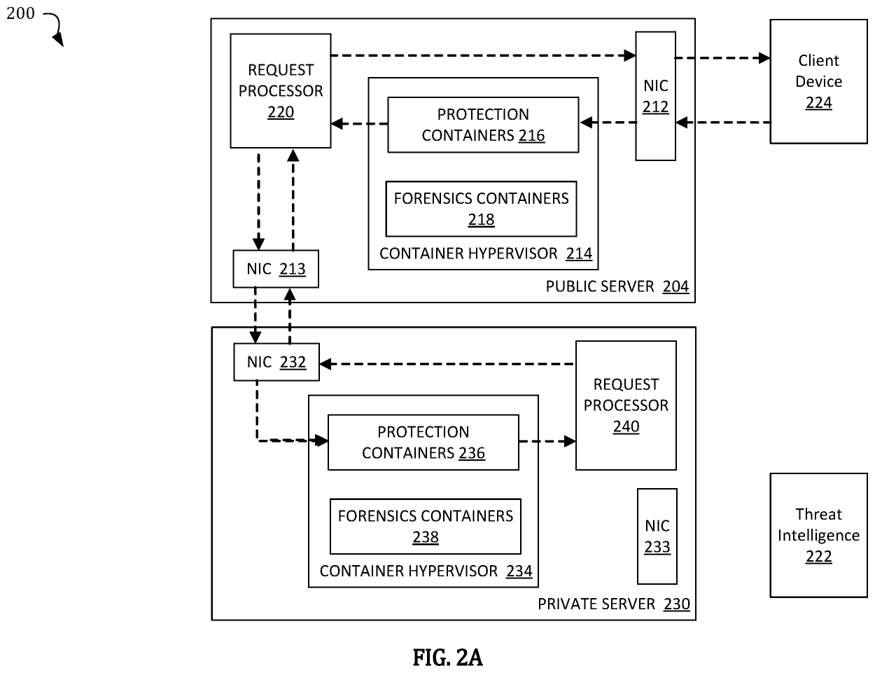

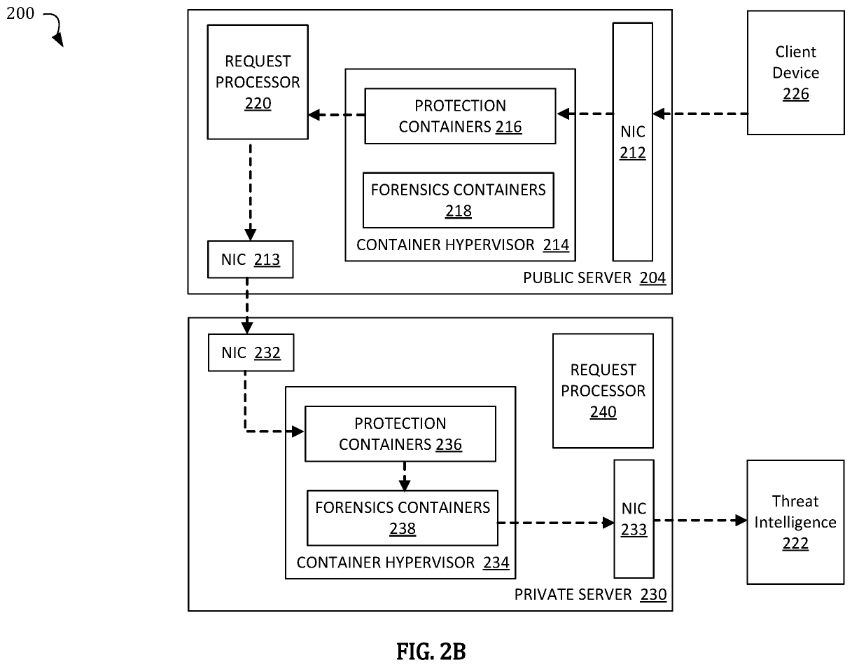

FIG. 2A and FIG. 2B show schematics of example flow paths of packet information received at a target public server 204 in communication with a private server 230. Specifically, FIG. 2A depicts a schematic of an example flow path for a valid query in a multiple-server system 200 for mitigating DDoS attacks. FIG. 2B depicts a schematic of an example flow path for an invalid query in a multiple-server system 200 for mitigating DDoS attacks (e.g., the query may be invalid as received from a client device 226 or may become invalid at a public server 204 of the multiple-server system 200).

In FIG. 2A, a client device 224 sends a valid query to the server 204. Similar to the flow path described in FIG. 1C for a valid query, the valid query from client device 224 is received by the server 204 at the NIC 212 and then directed from the NIC 212 to a container hypervisor 214. The container hypervisor 214 may be included in the NIC 212 or may exist on the server 204 separate from the NIC 212. The container hypervisor 214 may direct the valid query through at least one protection container(s) 216 and, because the query is valid, the valid query will be directed from the protection container(s) 216 to the request processor 220. In the example multiple-server system 200 shown in FIG. 2A, the request processor 220 may query a private server 230 to process and determine a response to the valid query via NIC 213, which may be the same or different than the NIC 212 from which the query was received from the client device 224 (e.g., over a private network not shown).

The private server 230 receiving a query from the public server 204 may also include a container hypervisor 234, which may have similar features to that of other container hypervisors described herein. For example, the query received by the private server 230 from the public server 204 may be received at a NIC 232 and directed to protection containers 236 associated with a container hypervisor 234. Because the query from the public server 204, which is based on the valid query received from client device 224, is valid, the query may be sent from the protection containers 236 to the request processor 240 of the private server 230 for processing and generating a response. The protection containers 236 on the private server 230 may be the same or different than the protection containers 216 on the public server 204. The response may then be sent to the request processor 220 via NIC 232 and NIC 213 (e.g., over a private network). The request processor 220 may then send the response to the client device 224 via the NIC 212.

In FIG. 2B a query in the multiple-server system 200 is determined to be malicious by a private server 230. In the flow path shown in FIG. 2B, the query may be invalid as received from a client device 226 or may become invalid at a public server 204 (e.g., the public server is corrupted). As shown, a client device 226 sends a query to public server 204. Similar to the flow paths described in FIGS. 1C and 1D, the query from client device 226 is received by the server 204 at the NIC 212 and then directed from the NIC 212 to a container hypervisor 214. The container hypervisor 214 may direct the query through one or more protection containers 216. In the example shown in FIG. 2B, the query is not filtered out or scrubbed by the protection containers 216 and is instead sent from the protection containers 216 to the request processor 220 of the public server 204. If the query from the client was invalid or malicious when received by the public server 204, then this example shows the protection containers 216 erroneously not filtering the query. A malicious query may circumvent the protection containers in some circumstances, such as the query being associated with a new or unidentified form of attack, the public server 204 being compromised, protection containers 216 needing to be updated, an improper selection or layout of protection containers 216, etc. Alternatively, if the query from the client was valid when received by the public server 204, then this example shows the query correctly reaching the request processor 220 along with other clean queries. In the example multiple-server system 200 shown in FIG. 2B, similar to the relationship of the public server 204 and private server 230 shown in FIG. 2A, the request processor 220 may send a query to a private server 230 to process and determine a response to the query via NIC 213.

The private server 230 receives the query from the public server 204 at the NIC 232 and directs the query to protection containers 236, associated with a container hypervisor 234. The private server 230 may make an independent assessment of the query (e.g., as valid/clean or invalid/malicious) regardless of any filtering previously performed by the public server 204. As described above, in some examples, the query might not be properly filtered by the public server 204, the query may be modified by the public server (e.g., if the public server is infected), or the query may be disguised by the public server 204 to appear as if the query originated from a client (e.g., a malicious query that originates from a public server 204 that is corrupted).

In the example shown in FIG. 2B, the query from the public server 204 is malicious (e.g., received at the public server 204 from the client device 226 as malicious and not filtered by the public server 204, originating from the public server 204 but disguised as originating from a client and is malicious, and/or received by public server 204 from the client device 226 as valid but modified by the public server 204 to become malicious, etc.). The query may be directed to the protection containers 236 of the container hypervisor 234 and filtered, then directed to the forensics containers 238 (e.g., similar to the flow path from protection services 117A-C to forensics containers 118 shown in FIG. 1D). By filtering the query in the protection containers 236 and directing the query to the forensics containers 238, the request processor 240 of the private server 230 is protected from the malicious query, based on the independent assessment of the query made at the private server 230. The forensics containers 238 may extract or determine forensic information to be analyzed by a threat intelligence system 222. The forensic information may then be sent to the threat intelligence system 222 from the forensics containers 238 of the private server 230 via a NIC 233, which may be the same or different than the NIC 232 from which the query from the public server 204 was received.

As an example, the multiple-server system 200 and the flow paths shown in FIG. 2A and FIG. 2B may be applied to a domain name system (DNS). In this example, a client (e.g., client device 224 or client device 226) desires to visit a website. The client sends a query to a public DNS server (e.g., public server 204) over a network. The system that is hosting the public DNS server application directs the packet information into a container hypervisor (e.g., container hypervisor 214). The container hypervisor receives the packet information and then requests, receives, and allocates computing resources to containers (e.g., protection containers 236 and/or forensics containers 238) based on attributes or characteristics of the query and/or containers (e.g., greater quantity of resources may be required for larger packet sizes, a greater number of containers, etc.). If, based on the query being directed through protection containers, the query is determined to be clean or valid, then the query is directed from the protection containers to a DNS resolver or processor (e.g., request processor 220) of the public DNS server for processing, which may also involve querying a private DNS server (e.g., private server 230). The response determined by the DNS resolver may then be sent to the client.

If, alternatively, based on the query being directed through protection containers, the query is determined by the container hypervisor to be malicious, then the query is directed from the protection containers to forensics containers (e.g., forensics containers 218) for forensic information extraction. The forensic information may then be sent to a threat intelligence system (e.g., threat intelligence system 222) for analysis. As shown in FIG. 2A and FIG. 2B, the determination of if the query is malicious or valid may be performed by containers associated with container hypervisors on both the public DNS server and/or the private DNS server. For example, integrating a container hypervisor onto both a public DNS server and private DNS server may prevent malicious traffic from impacting a private DNS server in the event the public DNS server is compromised. Although examples are applied to DNS, any server capable of hosting a container hypervisor may apply the techniques described herein.

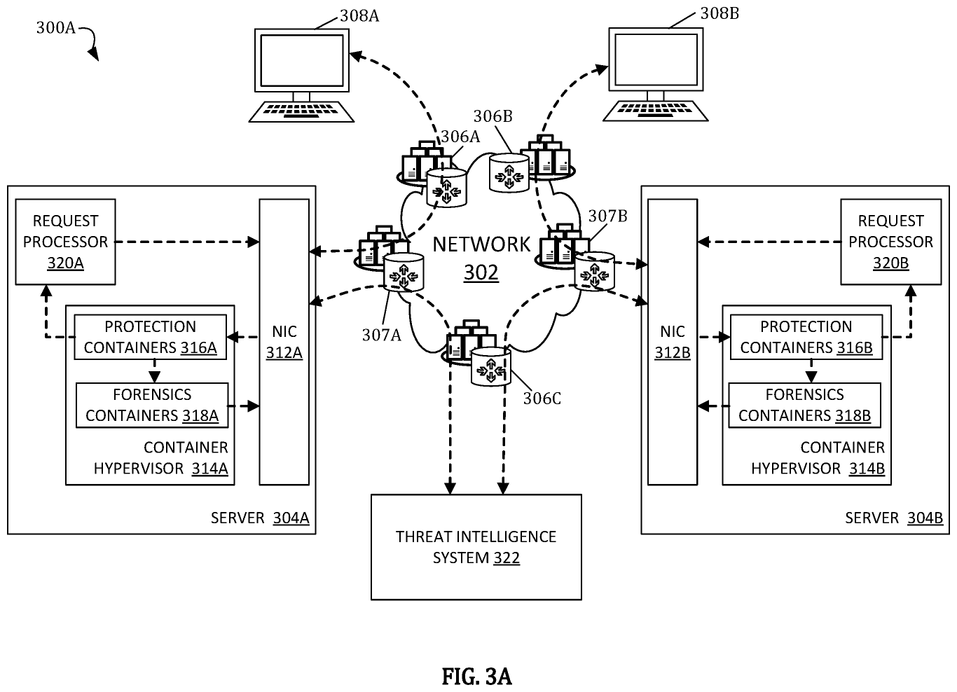

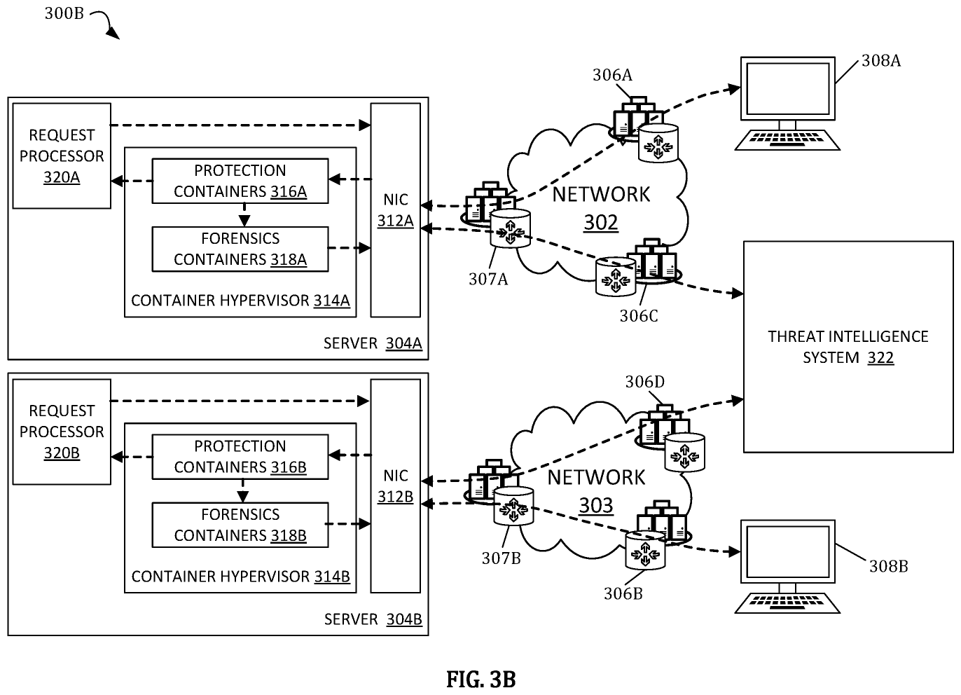

FIG. 3A and FIG. 3B show example systems for mitigating DDoS attacks across one or more networks, including flow paths between a threat intelligence system 322 and servers 304A, 304B. Specifically, FIG. 3A depicts an example system 300A for mitigating DDoS attacks across a network. FIG. 3B depicts an example system 300B for mitigating DDoS attacks across multiple networks.

In FIG. 3A, a first client device 308A may query a first server 304A over network 302 and a second client device 308B may query a second server 304B over the same network 302 (e.g., via the methods and systems described herein). The servers 304A, 304B may each, individually send forensic information determined by the forensics containers 318A, 318B to a threat intelligence system 322.

In FIG. 3B, a first client device 308A may query a first server 304A over network 302 and a second client device 308B may query a second server 304B over a different network 303 (e.g., via the methods and systems described herein). The servers 304A, 304B may each, individually send forensic information determined by the forensics containers 318A, 318B to a threat intelligence system 322.

The threat intelligence system 322 may implement machine learning or artificial intelligence techniques to analyze and learn from forensic information provided by one or more servers across one or more networks. The threat intelligence system 322 may receive information from multiple sources, such as one or more servers across one or more networks. For example, information received by the threat intelligence system 322 may be collected in a collaborative effort from commonly owned networks, on known sources of botnet hosts, based on traffic signatures, or any other discovered or related information shared from other providers or networks. The threat intelligence system 322 may include a feedback loop with a server or multiple servers. For example, the threat intelligence system 322 may provide information to modify container(s) in a container hypervisor of a server as the threat intelligence system 322 receives new or evolving forensic information from the container hypervisor of the server. Additionally or alternatively, updating the information to modify container(s) on a server may be based on forensic information received from other sources (e.g., forensic information from other servers, manually updated, or information from other external sources). Information sent by the threat intelligence system 322 to modify protection service(s) may be distributed to selective container hypervisors of selective servers. For example, modification of protection service(s) or protection container(s) may be specific to a network, business, service type, location, or other server characteristic or attribute. For example, if a threat is determined to be location-specific, servers outside of the affected location may not be sent container modification information, such that servers not likely to be subject to attack are not unduly taxed or burdened without reason.

Referring to FIG. 3A, by receiving and analyzing forensic information from multiple servers 304A, 304B on the same network 302, the threat intelligence system 322 may process forensic information that is network-specific. For example, the threat intelligence system 322 may determine malicious traffic patterns associated with the shared network, how malicious attacks vary across the same network, and techniques for informing, updating, or taking action for security measures for some or all servers in the shared network 302. In the example shown in FIG. 3A, client device 308A may send a malicious query to server 304A, which may be filtered by protection containers 316A. Forensic information associated with the malicious query may be determined by forensics containers 318A and sent to the threat intelligence system 322. The threat intelligence system 322 may analyze the forensic information and determine that one or more protection services on the originating server (e.g., server 304A) and/or protection services on other servers in the network (e.g., protection containers 316B and/or forensics containers 318B on server 304B) may be improved (e.g., may be updated, removed, added, or otherwise modified to improve security of a server with a container hypervisor 314A, 314B).

Referring to FIG. 3B, the threat intelligence system 322 may receive and analyze forensic information from multiple servers 304A, 304B from different networks 302, 303. The threat intelligence system 322 may determine malicious traffic patterns across different networks, how malicious attacks vary across networks, and techniques for informing, updating, or taking action for security measures for some or all servers over different networks. In the example shown in FIG. 3B, client device 308A may send a malicious query to server 304A, which may be filtered by protection containers 316A. Forensic information associated with the malicious query may be determined by forensics containers 318A and sent to the threat intelligence system 322. The threat intelligence system 322 may analyze the forensic information and determine that one or more protection services on the originating server (e.g., server 304A) and/or protection services on other servers on different networks (e.g., protection containers 316B and/or forensics containers 318B on server 304B across network 303) may be improved (e.g., may be updated, removed, added, or otherwise modified to improve security of a server with a container hypervisor 314A, 314B).

FIG. 4 depicts an example of a suitable operating environment 400 that may be implemented by a client device, a DDoS system or server, and/or other computing devices within the systems discussed herein. In its most basic configuration, operating environment 400 typically includes at least one processing unit 402 and memory 404. The processing unit may be a processor, which is hardware. Depending on the exact configuration and type of computing device, memory 404 (storing, instructions to perform the motion detection techniques disclosed herein) may be volatile (such as RAM), non-volatile (such as ROM, flash memory, etc.), or some combination of the two. This most basic configuration is illustrated in FIG. 4 by dashed line 406. The memory 404 stores instructions that, when executed by the processing unit(s) 402, perform the processes and operations described herein, such as directing traffic through a container hypervisor, analyzing packet information in protection container(s) and forensic container(s), updating protection container(s), rerouting traffic, etc. Further, the operating environment 400 may also include storage devices (removable 408, and/or non-removable 410) including, but not limited to, solid-state, magnetic disks, optical disks, or tape. Similarly, the operating environment 400 may also have input device(s) 414 such as keyboard, mouse, pen, voice input, etc. and/or output device(s) 416 such as a display, speakers, printer, etc. Additional communication connections 412 may also be included that allow for further communication with LAN, WAN, point-to-point, etc. Operating environment 400 may also include geolocation devices 420, such as a global positioning system (GPS) device.

Operating environment 400 typically includes at least some form of computer readable media. Computer readable media can be any available media that can be accessed by processing unit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

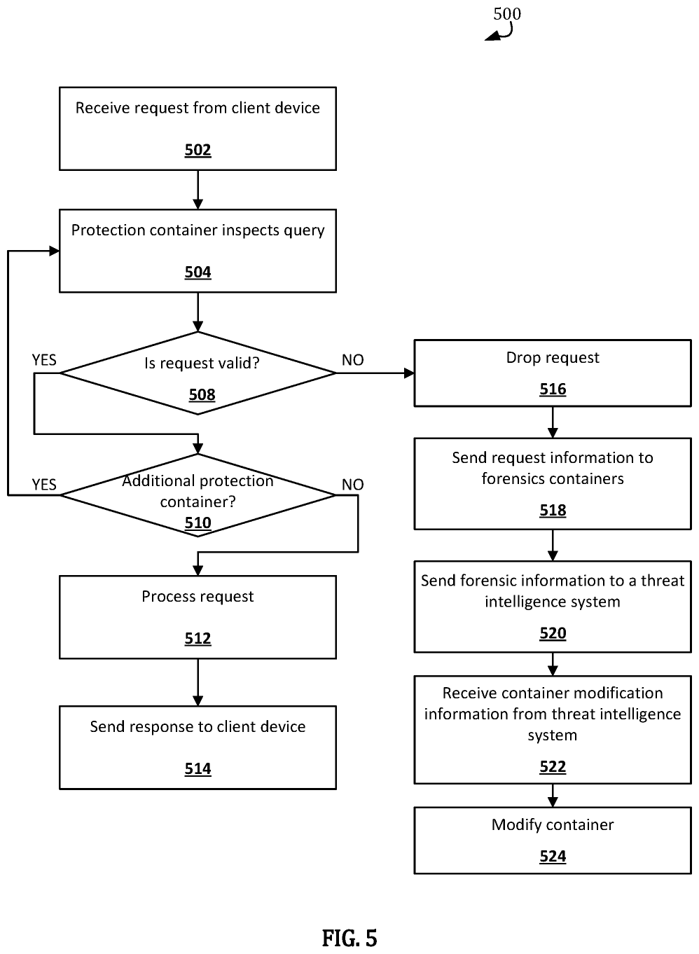

FIG. 5 depicts an example method 500 for a lightweight, tuned DDoS protection system. At operation 502, a request (otherwise referred to herein as a query, packet, or traffic) is received from a client device. The client device may send the request over a network to a server hosting the DDoS protection system. The request may be received by the server at a NIC. At operation 504, the query is inspected by a protection container. The protection container may be included in a container hypervisor for management and allocation of server resources to the protection container. Additionally, the protection container and container hypervisor may be located on the NIC or outside of the NIC. In either location, the query is directed to the protection container for evaluation upon receipt of the request (e.g., prior to the request being directed either to a processor of the server, to another container, or outside of the server such as to a threat intelligence system).

At determination 508, it is determined if the query is valid. The protection container may include one or more protection services for evaluation of the request. For example, the request may be evaluated based on identified or determined request characteristics, such as location of the client device where the request originated (e.g., city or country), an IP address of the client device, a packet size, server resources to be tasked by the request (e.g., kernel, CPU, operating system, etc.), a packet bandwidth, metadata, etc. The request characteristic(s) may be compared or evaluated against protection services of the protection container. In an example, the protection service may implement an access control mechanism for one or more components of the request characteristic(s), such as block lists, allow lists, etc. In an instance, a request originating from certain IP addresses may be on an allow list and thus determined to be a valid query. In another example, a request originating from a certain city with a packet size less than a specified threshold may be determined to be valid. Alternatively, requests tasking certain server resources may be determined to be malicious or invalid, or requests originating from a certain country with a packet size larger than a specified threshold may be determined to be malicious or invalid.

If it is determined at operation 508 that the query is valid, flow proceeds as “YES” to determination 510 where it is determined if there is an additional protection container to be applied. A container hypervisor may include multiple protection containers with one or more protection schemes. The protection containers may be placed in series or in parallel for flow of traffic in the container hypervisor. The request may be selectively directed through protection containers. For example, a first protection container may evaluate a first request information component and second protection container may evaluate a second request information component. In another example, a first protection container may identify and evaluate request information components individually and a second protection container may evaluate combinations of request information components. If an additional protection container is available or desirable to evaluate the request, flow proceeds to “YES” where operations 504-510 may repeat as required or desired. If, alternatively, there are no additional protection containers, flow proceeds as “NO” to operation 512 where the query is processed. Processing of the request may include determining and generating a response to the request. At operation 514, a response to the request is sent to the client device. For example, a response generated by a processor of the server may be sent out of the server at the NIC and over a network to be received by the client device.

If, however, at determination 508 the request is not determined to be valid, or determined to be malicious or invalid, flow proceeds as “NO” to operation 516 where the request is dropped such that the request will not reach the processor of the server. At operation 518, request information (e.g., one or more request characteristic(s) that may or may not have been evaluated by protection containers, request metadata, etc.) is sent to one or more forensics container(s). The forensics containers may gather forensic information based on invalid requests. The forensic information may be based on each individual invalid request or may aggregated for multiple invalid requests.

At operation 520, forensic information is sent to a threat intelligence system. For example, the forensic information determined by the forensics containers may be sent out of the server at a NIC (which may be the same or different than the NIC at which the request was received) and over a network (which may be the same or different than the network over which the request was received). The threat intelligence system may analyze the forensic information from the server and/or other servers to determine improvements for the protection containers, flow path through the containers (e.g., arrangement of the containers), replacements for one or more containers (e.g., protection container and/or forensic container), etc.

At operation 522, container modification information is received from the threat intelligence system (e.g., at a NIC and over a network). The modification information is directed to the container hypervisor so that the container hypervisor is instructed to modify containers based on the modification information. At operation 524, the containers are modified based on the modification information from the threat intelligence system.

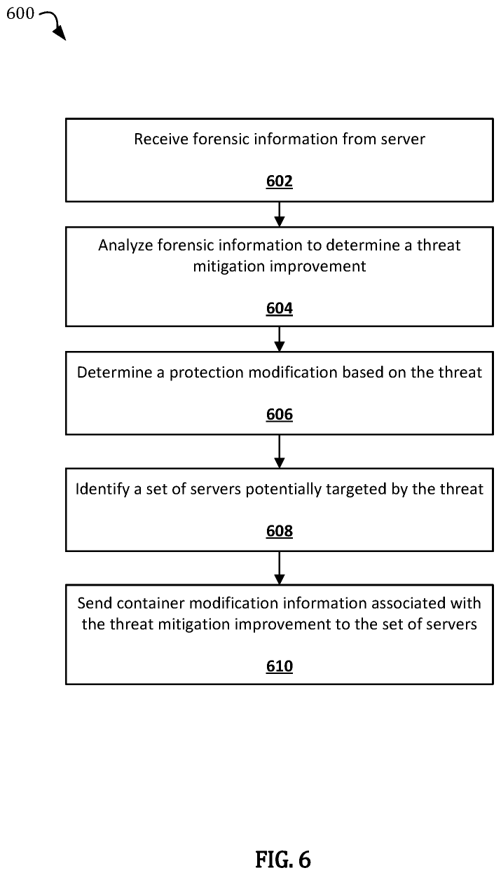

FIG. 6 depicts another example method 600 for modifying containers of a lightweight, tuned DDoS system. At operation 602, forensic information is received from a variety of sources, such as one or more servers (e.g., a server with a container hypervisor and containers, as described herein), across one or more networks, manually or directly, etc. The forensic information may be sent over a network for receipt by a threat intelligence system. At operation 604, the forensic information is analyzed to determine an improvement to containers (e.g., of a container hypervisor on a server), based on a threat associated with the forensic information.

At operation 606, a protection modification is determined, based on the threat. For example, the threat intelligence system may determine that aspects of containers (e.g., which containers, arrangement of containers, flow path through containers, quantity of containers, etc.) associated with a set of container hypervisors may be modified (e.g., removing, adding, rearranging, updating, etc. of a container) to improve protection from future attacks. For example, based on forensic information, the threat intelligence system may determine that an IP address is associated with multiple invalid requests (e.g., across multiple servers or multiple requests to the same server) and therefore determine that the specific IP address should be blocked for improved protection (e.g., add the specific IP address to a blocklist).

At operation 608, a set of servers are identified as potential targets of the threat. Continuing the example above for a malicious specific IP address, the threat intelligence system may determine that the IP address has been targeting servers with target characteristics (e.g., associated with specific services, businesses, locations, etc.). A set of servers associated with the target characteristic may be identified by the threat intelligence system as requiring or desiring a modified protection scheme to protect against attacks from the specific IP address. In some examples, a protection modification may apply to all servers and may not be limited or targeted based on a shared target characteristic (e.g., distributed to all servers with a hypervisor container).

At operation 610, container modification information associated with the threat mitigation improvement is sent to the set of servers associated with the target characteristic. The modification information may be sent over one or more networks for receipt by one or more servers to modify one or more containers of a container hypervisor. The modification information may be sent to a limited number of servers (e.g., the set of servers associated with the target characteristic), so that servers that are not likely to be impacted by the identified threat are not unduly burdened by frequent modifications that may be unnecessary.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurements techniques utilized herein. To the extent such terms may not be clearly defined or understood by one having skill in the art, the term “about” shall mean plus or minus ten percent.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A computer-implemented method for hosting a container hypervisor for mitigating a distributed-denial-of-service (DDoS) attack, the computer-implemented method comprising:
hosting the container hypervisor on a server, the container hypervisor comprising a set of protection containers;
receiving a query from a client device over a network;
directing the query to a protection container of the set of protection containers, the protection container associated with a protection scheme based on at least one query characteristic;
determining that the query is valid, based on the protection scheme; and
based on determining that the query is valid, directing the query to a processor of the server for processing.

2. The computer-implemented method of claim 1, the method further comprising:
processing the query to generate a response; and
sending the response to the client device over the network.

3. The computer-implemented method of claim 1, wherein the container hypervisor requests, manages, and allocates computing resources of the server based on one of: the query and the set of protection containers.

4. The computer-implemented method of claim 1, wherein the protection container is a first protection container, the protection scheme is a first protection scheme, and wherein the set of protection containers includes a second protection container associated with a second protection scheme.

5. The computer-implemented method of claim 3, the method further comprising:
based on determining that the query is valid based on the first protection scheme, directing the query to the second protection container; and
determining that the query is valid based on the second protection scheme, wherein directing the query to the processor is based on determining that the query is valid based on the first protection scheme and the second protection scheme.

6. The computer-implemented method of claim 1, wherein the server is a first server, the method further comprising:
querying a second server, by the processor of the first server, to generate a response to the query.

7. The computer-implemented method of claim 6, wherein the first server is a public server and the second server is a private server.

8. The computer-implemented method of claim 6, wherein the container hypervisor is a first container hypervisor with a first set of protection containers hosted on the first server and wherein the second server is hosting a second container hypervisor with a second set of protection containers.

9. The computer-implemented method of claim 7, wherein the first set of protection containers differs from the second set of protection containers based on one of: including different protection containers and arrangement of containers.

10. The computer-implemented method of claim 7, the method further comprising:
directing the query through the second set of protection containers;
determining that the query is valid, based on the second set of protection containers;
based on determining that the query is valid based on the second set of protection containers, directing the query to a second processor of the second server for processing;
processing the query at the second processor to generate the response; and
sending the response to the first server.

11. The computer-implemented method of claim 7, wherein determining that the query is valid is based on a query characteristic, wherein the query characteristic is one of:
a location of the client device;
a location of the server;
an IP address of the client device;
a packet size;
a packet bandwidth; and
a computing resource associated with generating a response to the query.

12. The computer-implemented method of claim 11, wherein the container hypervisor is a first container hypervisor with a first set of protection containers hosted on the first server and wherein the second server is hosting a second container hypervisor including a second set of protection containers and a set of forensics containers, the method further comprising:
directing the query through the second set of protection containers;
determining that the query is invalid, based on the second set of protection containers and the query characteristic;
based on determining that the query is invalid, directing the query to the set of forensics containers;
identifying forensic information based at least in part on the query characteristic; and
sending the forensic information to an external system.

13. The computer-implemented method of claim 12, wherein the container the forensic information is an aggregation of query characteristics including the query characteristic associated with the invalid query.

14. The computer-implemented method of claim 2, wherein the query is a first query, the client device is a first client device, and the hypervisor container further includes a set of forensics containers, the method further comprising:
receiving a second query from a second client device over the network;
directing the second query to the protection container of the set of protection containers;
determining that the second query is invalid, based on the protection container and a query characteristic;
based on determining that the second query is invalid, directing the second query to the set of forensics containers;
identifying forensic information based at least in part on the query characteristic; and
sending the forensic information to an external system.

15. The computer-implemented method of claim 14, wherein the second query is not received by the processor of the server.

16. The computer-implemented method of claim 14, the method further comprising:
receiving container modification information from the external system, the container modification information based at least in part on the forensic information; and
updating the set of protection containers based on the container modification information.

17. A computer-implemented method for hosting a container hypervisor for mitigating a distributed-denial-of-service (DDoS), the computer-implemented method comprising:
hosting the container hypervisor on a server, the container hypervisor comprising a set of protection containers and a set of forensics containers;
receiving a query from a client device over a network;
directing the query through the set of protection containers;
determining that the query is malicious, based on at least one protection container of the set of protection containers and a query characteristic;
based on determining that the query is malicious, directing the malicious query through the set of forensics containers;
identifying forensic information based at least in part on the query characteristic; and
sending the forensic information to a threat intelligence system external to the server.

18. The computer-implemented method of claim 17, wherein the query characteristic is one of:
a location of the client device;
a location of the server;
an IP address of the client device;
a packet size;
a packet bandwidth; and
a computing resource associated with generating a response to the query.

19. The computer-implemented method of claim 17, the method further comprising:
receiving container modification information from the threat intelligence system, the container modification information based at least in part on the forensic information; and
updating the set of protection containers based on the container modification information.

20. A system for hosting a container hypervisor for mitigating a distributed-denial-of-service (DDoS), the system comprising:
a processor; and
memory storing instructions that when executed by the at least one processor cause the system to perform a set of operations comprising:
hosting the container hypervisor on the system, the container hypervisor isolated from the processor and comprising a set of protection containers and a set of forensics containers;
receiving a query from a client device;
directing the query to the container hypervisor through the set of protection containers;
determining that the query is invalid, based on at least one protection container of the protection containers and a query characteristic associated with the query;
based on determining that the query is invalid, directing the query through the set of forensics containers;
identifying forensic information based at least in part on the query characteristic; and
sending the forensic information form the container hypervisor to a threat intelligence system external to the server.
